(19) United States
(12) Patent Application Publication
(10) Pub. No.: US 2009/0154759 A1
(43) Pub. Date: Jun. 18, 2009

(54) METHOD, USER INTERFACE, APPARATUS AND COMPUTER PROGRAM PRODUCT FOR PROVIDING A GRAPHICAL CODE PATTERN

(75) Inventors: Sanna M. Koskinen, Tampere (FI); Paivi Heikkila, Tampere (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/957,595

(22) Filed: Dec. 17, 2007

(51) Int. Cl. G06K 9/00; G06K 9/36

(52) U.S. Cl. 382/100; 382/232

(57) ABSTRACT

A method for generating a graphical code pattern from a multimedia content, the method including receiving one or more input and in response editing the multimedia content, encoding the multimedia content into a graphical code pattern, displaying the generated graphical code pattern, and concurrently with the editing, encoding the multimedia content into the graphical code pattern and displaying the image of the graphical code pattern, such as to provide a preview of the graphical code pattern.

### FIELD

The disclosed embodiments relate to a method for generating a graphical code pattern, and a user interface, a communications terminal and a computer program product for performing the method.

### BACKGROUND

New uses for cameras of communications terminals are emerging. One is the generation, capturing and interpretation of one-dimensional codes, for instance bar codes, comprising pieces of coded information. Visual codes are both fun and convenient, and there are many fields of applications.

Two-dimensional (2D) code, is an advanced form of the one dimensional barcode and comes in several different standard formats, holding more information than a bar code because of its matrix structure. With recent technological development, camera phones can now be used to scan the 2D codes, decode them and display the information within them. 2D codes are emerging in many fields of application, such as on business cards and Curriculum Vitaes, as tags on flyers and posters and in magazines and Internet forums and blogs. They offer easy access to for example web addresses and offer the possibility to save information via scanning without having to type in the information it self.

Code generators are also available on the Internet, in which information can be entered and transformed into 2D code, either in a simple text field or for example a business card template, and by pressing a button the code is generated and displayed.

The patent applications JP20050291657 and CN200510061096 disclose how information can be transferred from business cards for example to the phone via a 2D code and a bar code reader implemented in a mobile phone. Patent application JP20040180314 and U.S. Pat. No. 6,974,078 disclose how the 2D code is used retrieving a web page via a 2D code scanned from a mobile phone.

The complexity and size of a code vary according to the amount of information contained in the code. Due to limitations in the equipment producing or capturing a code, the quality of a code may vary, and information may be lost or corrupted. Sometimes the code is not readable with a code reader, because the code reader can not distinguish the details in the code from each other. This is especially a problem with portable devices, such as communication terminals, which due to limited size and quality of components, often suffer from limitations from for instance the equipment being used for these purposes. A code often becomes too big or complicated and may be difficult to read or interpret, sometimes not readable at all. As a result, the image of a code may be distorted, due to loss of information, having as a consequence that the information in the code becomes corrupted. In addition, the appearance of a code may also be of a personal taste or preference.

Solutions could involve setting restrictions to the code generator, such as involving setting of a maximum number of characters to be converted into code, or setting of a maximum code size, which could be related to the number of characters being converted. However, this is not easy to implement, since limits for the code size and number of characters are different for different devices, due to properties and quality of the image acquirer. Also, some users want to enable scanning a code very quickly while others want to include more data in the code.

Another solution to achieve a desired result, is that a user can repeatedly request regeneration of the code while modifying the content. Hence, it is a cumbersome process of iterations since many steps are required to check the code's readability concurrently with writing the input for the code.

Hence, a problem with the prior art is thus for a user to achieve a desired result, for instance a code having an acceptable degree of complexity or size.

### SUMMARY

It would be advantageous to provide a method with which desired graphical code patterns easier can be achieved.

In a first aspect in accordance with the disclosed embodiments a method for generating a graphical code pattern from a multimedia content concurrently with editing of the multimedia content comprises, encoding the multimedia content into said graphical code pattern and displaying the image of said graphical code pattern, such as to provide a preview of said graphical code pattern. Hence, the intermediate results of a code may be presented during its preparation. The preview of the code is presented automatically, without the need for additional input besides the input provided for the preparation of the content. The preview may be displayed as an instant snapshot of the current state of the code of the currently provided content. Hence the image of the graphical code pattern is repeatedly refreshed to reflect the current multimedia content. Subsequent to presenting a preview, the terminal may be instantly ready to receive a new input, such as another character. This makes it easier for a user to achieve a desired result, for instance a code having an acceptable degree of complexity or size. Thus, a user is presented with a preview of the code, and can therefore make adjustments to the information and instantly see how it affects the code. The preview can be displayed as shown in FIG. 5 or the content area and the graphical code pattern can be overlapping so the graphical code pattern is displayed in the background of the content. Thus, it is easier and quicker to monitor the quality of the code and also to allow convenient creation of desired, readable and interpretable codes. As a further advantage, it is possible with the invention to ensure that the code is readable, as in not too complex, before the code is finalized and distributed. Additionally, a user can easily share any information that is transformable into a graphical code image and at the same time make sure the code is readable for others.

According to an embodiment, the encoding and/or displaying is performed essentially in real time, in instant response with the receipt of an input, such as to continuously provide a current preview of the graphical code pattern. Hence, the preview represents an instant representation of the code corresponding to the currently prepared multimedia content. This makes it possible for the user to immediately adjust the content to achieve a desired code.

According to another embodiment, the encoding and/or displaying is performed repeatedly after predetermined time intervals. Thereby, a preview of the code is automatically regularly generated, without the need for a user interaction. This makes it possible to preview images of the code that are automatically made regularly and readily available.

According to yet another embodiment, the encoding and/or displaying is performed repeatedly upon receipt of a predetermined number of input representative of editing actions of said multimedia content. Hence, a preview image of the code may be presented upon a predetermined number of for instance key strokes. This makes it possible to preview images of the code that are automatically made regularly.

The above, together with numerous other advantages and features, which will become evident from the below description, are accomplished according to a second aspect by a terminal adapted for generating a graphical code pattern from a multimedia content comprising a user interface, a processor, a display, and an input acquirer, wherein said input acquirer is adapted to receive an input, said processor is adapted to encode said input into a graphical code pattern, and said display is adapted to display an image of said graphical code pattern, wherein the processor and display are adapted to concurrently with said input acquirer receiving input, encoding and displaying the image of said graphical code pattern, such as to provide a preview of said graphical code pattern.

According to an embodiment, the graphical code pattern is matrix code, barcode, two dimensional, three dimensional, or any combinations thereof. Hence, various code formats may be implemented with the present invention.

According to an embodiment, the multimedia content is a text string, an image, a sound clip or any combinations thereof. Hence, various multimedia content formats, including video, may be used with the present invention, but the content formats are not limited to the examples mentioned here.

According to another embodiment, the image preview has an image resolution lower than that of an actual representation of the code. Thereby, limited processing resources suffice to continuously updating the image preview of the code, such that overall appearance of the code can be visually appreciated before generating a complete image of the code. For instance, minor details will update less frequently. In other words, the preview may provide a partial snapshot of the code being generated with reduced resolution. As an advantage, slow update in a case of reduced processing capacity or power-saving may be avoided.

According to another embodiment the presentation of the graphical code pattern is initiated at the end of a predetermined time interval from last received input. Hence, as a user pauses during creation of a piece of information to be converted into a code, the user is presented with an updated preview of the code from the current content of the information. This can be seen as a way of reducing processing power.

The above embodiment, together with numerous other embodiments, advantages and features, which will become evident from the below description, are accomplished according to a third aspect by a computer program product, such as a computer-readable medium, comprising software instructions that, when executed in an electronic apparatus, performs the method according to said first aspect of the present invention.

In a further embodiment, the multimedia content acquirer is adapted to receive textual input, for example through a keyboard or a touch screen, enabling a user to clearly convey the message through words. To enhance understanding the device can contain a text-to-speech functionality where the device speaks out the inputted text.

In another embodiment, the content acquirer is an image acquirer, such as a camera, which can be integrated in the phone or an externally connected. In this way the user can photograph to information the user wanted to convert into 2D code. The photo can contain text which then can be extracted from the picture and turned into a 2D code.

The display is adapted to render an image of the generated 2D code. This enables the user to check the code's complexity before the code is finalized. The display may for instance comprise a split view where one side the input is displayed and on the other the code. Another option is to have tabs so the user can change between a view of the input and a view of the 2D code.

The content being turned into 2D code can be, but not limited to, a web address, a string of symbols, a photo, a film, an animation, a phone number, a file, a business card or an e-mail address, or any combinations thereof. Hence, data previously necessary to be manually entered by a user or transferred through other means like a computer, may now be easily accessible, storable and sharable. In case of encoding files, films and animations, to be shared and distributed on a network, these could advantageously be shared via for instance a multi media service (MMS).

In one embodiment, the communication terminal may be a cellular phone, a Personal Digital Assistant (PDA), a computer, an internet device, a tablet computer, a media player or any other terminal used for communication. Hereby the user can choose a preferred device.

According to various other embodiments, the graphical code pattern may be, but not limited to, Quick Response (QR) code, micro QR code, PDF417, DataMatrix, Maxi Code, MiniCode, ezCode, Aztec code, Codablock, ShotCode Vericode, Datastrip Code, CP Code, IIS SuperCode, Dot Code, Bee Tagg code, PaperDisk, mCode, 3-DI Code, Code 1, Snowflake, optical intelligence 2D or any combinations thereof. The code may further be one dimensional or have more dimensions than two. Hence, a code part of a standard may be widely spread and more accepted, and more people will be able to read the code and to send a code that is readable to others. It is also possible to for instance choose between formats to find one that best can contain the information the user wants communicated.

According to a further embodiment, the presentation of the content and code involves presentation on a display, such that readability of the generated code can be visually inspected. Optionally, the code may be inspected via optical projecting an image of the code onto an external object such as a wall, floor or a sealing. In addition, the readability may be even further evaluated by having a code reader scan the code, either the projected one or the one displayed on the display. After the image of the code has been projected, the projected image can be acquired by the terminal by the image acquirer and interpreted by the decoder. Hence, the code's readability may instantly be assessed.

The above embodiment, together with numerous other embodiments, advantages and features, which will become evident from the below description, are accomplished according to a fourth aspect by a user interface comprising a display and an input acquirer wherein the input acquirer is arranged to receive user input to be converted into a graphical code pattern and the display is arranged to display the input and graphical code pattern, and the display is adapted to display an updated image of the graphical code pattern concurrently with the input acquirer receiving input.

The computer program product and user interface according to the third and fourth aspects of the disclosed embodiments respectively may comprise any features of the terminal according to the second aspect.

Other embodiments, features and advantages will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise.

The term terminal is to be interpreted as comprising the following, but not limited to: cell phones, PDA's, palm pilots and computers. The terms 2D code, two-dimensional code, graphical code pattern, matrix code or other terms in this category all covers essentially the same, that is the code that is generated from the user input, which comes in many standards, not all necessarily mentioned in this application. When the words prepare/draft/create/compose/edit/enter/generate are used for example in connection with content/information/data, this is to be interpreted openly and may be interpreted as covering the other instances mentioned here. Furthermore the words appearance/quality/characteristics of a code should also be interpreted openly as covering the mentioned instances here. The steps of any method disclosed herein do not have to be performed in the exact order disclosed, unless explicitly stated.

### BRIEF DESCRIPTION OF THE DRAWINGS

Embodiments will now be described in more detail, reference being made to the enclosed drawings, in which:

FIG. 1 is a schematic illustration of a cellular telecommunication system, as an example of an environment in which the disclosed embodiments may be applied.

FIG. 2 is a schematic front view illustrating a mobile terminal according to an embodiment.

FIG. 3 is a schematic block diagram representing an internal component, software and protocol structure of the mobile terminal shown in FIG. 2.

FIG. 4 shows schematically a flow diagram of how a graphical code pattern is generated according.

FIG. 5 shows an embodiment of the display when being used for generation of a graphical code pattern.

### DETAILED DESCRIPTION OF EMBODIMENTS

The disclosed embodiments will now be described more fully hereinafter with reference to the accompanying drawings, in which certain embodiments are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

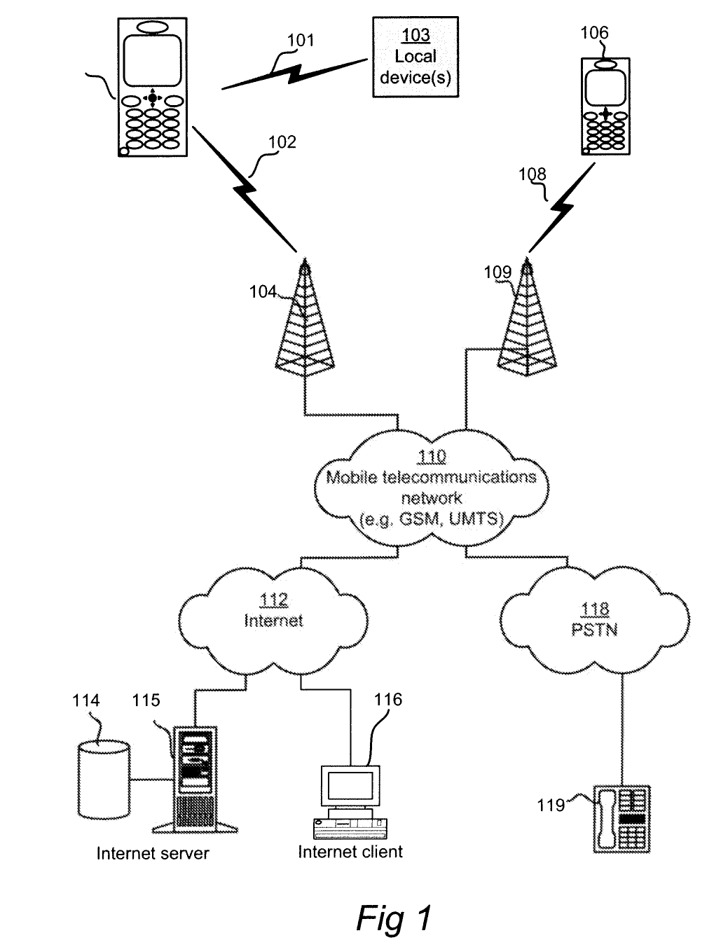

FIG. 1 illustrates an example of a cellular telecommunications system in which the disclosed embodiments may be applied. In the telecommunication system of FIG. 1, various telecommunications services such as cellular voice calls, world wide web (www)/wireless application protocol (wap) browsing, cellular video calls, data calls, facsimile transmissions, music transmissions, still image transmissions, video trans-missions, electronic message transmissions and electronic commerce may be performed between a mobile terminal 100 according to the disclosed embodiments and other devices, such as another mobile terminal 106 or a stationary telephone 119. It is to be noted that for different embodiments of the mobile terminal 100 and in different situations, different ones of the telecommunications services referred to above may or may not be available; the invention is not limited to any particular set of services in this respect. The mobile terminals 100, 106 are connected to a mobile telecommunications network 110 through radio frequency (RF) links 102, 108 via base stations 104, 109. The mobile telecommunications network 110 may be in compliance with any commercially available mobile telecommunications standard, such as Global System Mobile (GSM), Universal Mobile Telecommunications System (UMTS), Digital-Advanced Mobile Phone Service (D-AMPS), Code Division Multiple Access2000 (CDMA2000), (Freedom of Mobile Multimedia Access) FOMA and Time Division-Synchronous Code Division Multiple Access (TD-SCDMA). The mobile telecommunications network 110 is operatively connected to a wide area network 112, which may be Internet or a part thereof. An Internet server 115 has a data storage 114 and is connected to the wide area network 112, as is an Internet client computer 116. The server 115 may host a www/wap server capable of serving www/wap content to the mobile terminal 100. A public switched telephone network (PSTN) 118 is connected to the mobile telecommunications network 110 in a familiar manner. Various telephone terminals, including the stationary telephone 119, are connected to the PSTN 118. The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a recommended standard 232 (RS-232) serial link, etc.

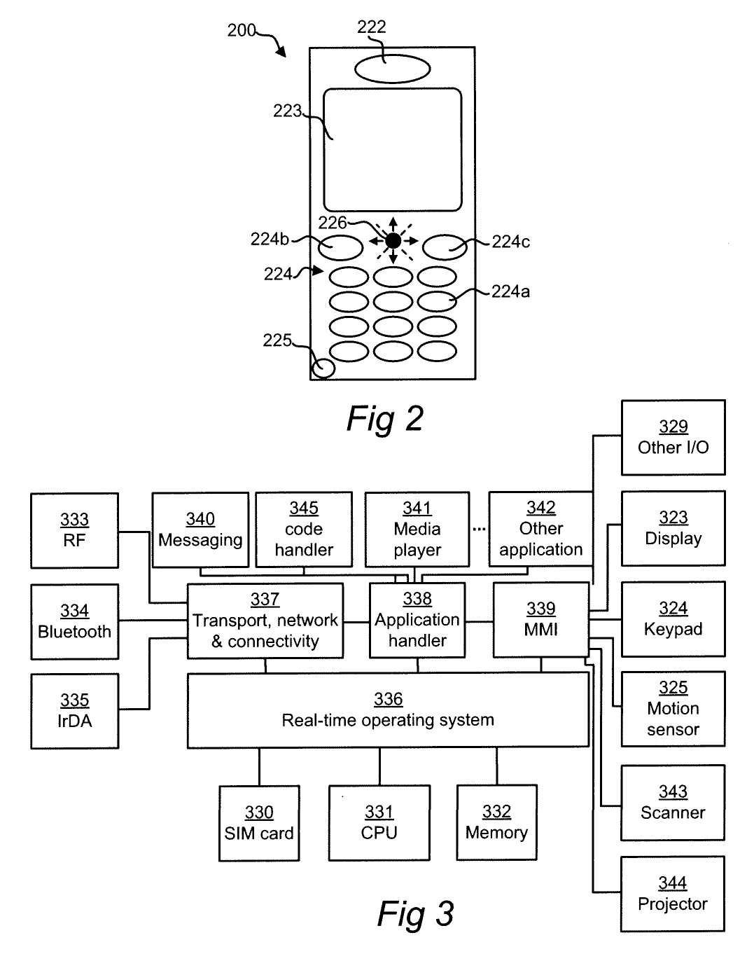

An embodiment 200 of the mobile terminal 100 is illustrated in more detail in FIG. 2. The mobile terminal 200 comprises a speaker or earphone 222, a microphone 225, a display 223 and a set of keys 224 which may include a keypad 224 a of common International Telecommunications Union Telecommunication Standardization Sector (ITU-T) type (alpha-numerical keypad representing characters “0”-“9”, “*” and “#”) and certain other keys such as soft keys 224b, 224c and a joystick 226 or other type of navigational input device.

The internal components, software and protocol structure of the mobile terminal 200 will now be described with reference to FIG. 3. The mobile terminal has a controller 331 which is responsible for the overall operation of the mobile terminal and is preferably implemented by any commercially available Central Processing Unit (CPU), Digital Signal Processor (DSP) or any other electronic programmable logic device. The controller 331 has associated electronic memory 332 such as random access memory (RAM), Read-only memory (ROM), Electrically Erasable Programmable Read-Only-Memory (EEPROM), flash memory, or any combination thereof. The memory 332 is used for various purposes by the controller 331, one of them being for storing data and program instructions for various software in the mobile terminal. The software includes a real-time operating system 336, drivers for a man-machine interface (MMI) 339, an application handler 338 as well as various applications. The applications can include a messaging application 340 for sending and receiving short message service (SMS), multimedia messaging service (MMS) or email, a code handler 345 including a code reader and code generator, a media player application 341, as well as various other applications 342, such as applications for voice calling, video calling, web browsing, an instant messaging application, a phone book application, a calendar application, a control panel application, a camera application, one or more video games, a notepad application, etc. The code handler 345 is further configured for encrypting and decrypting graphical code patterns according to the invention. The MMI 339 also includes one or more hardware controllers, which together with the MMI drivers cooperate with the display 323/223, keypad 324/224, motion sensor 325, such as an accelerometer, a scanner 343, a projector 344, as well as various other input/output (I/O) devices 329 such as microphone, speaker, vibrator, ring tone generator, light emitting diode (LED) indicator, etc. As is commonly known, the user may operate the mobile terminal through the man-machine interface thus formed. The software also includes various modules, protocol stacks, drivers, etc., which are commonly designated as 337 and which provide communication services (such as transport, network and connectivity) for aRF interface 333, and optionally a Bluetooth interface 334 and/or an Infrared Data Association (IrDA) interface 335 for local connectivity. The RF interface 333 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.e., band pass filters, amplifiers, mixers, local oscillators, low pass filters, analog-to-digital/digital-to-analog (AD/DA) converters, etc. The mobile terminal also has a subscriber identity module (SIM) card 330 and an associated reader. As is commonly known, the SIM card 330 comprises a processor as well as local work and data memory.

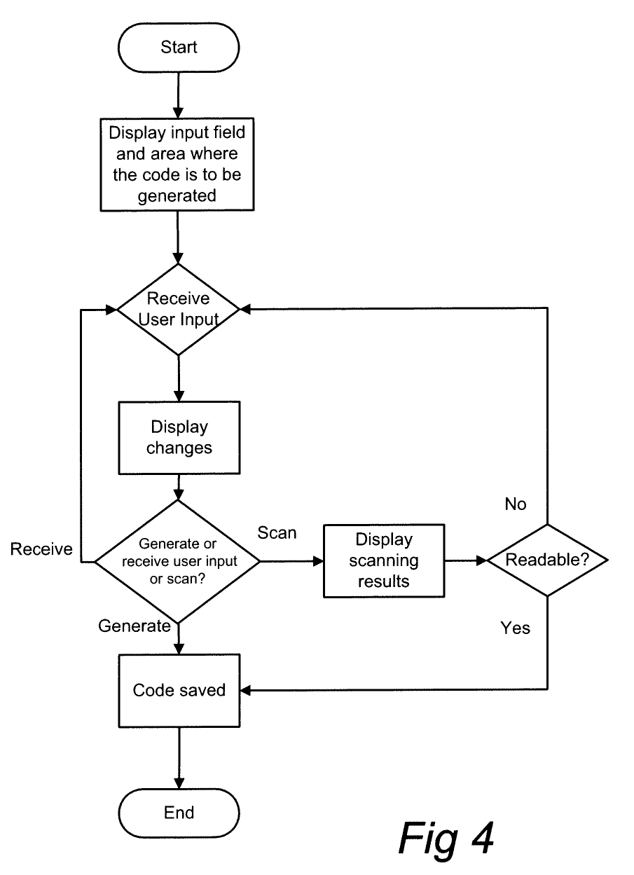

FIG. 4 is a flow diagram of how graphical code patterns are generated from a terminal's point of view. The terminal is set up to receive user input such has text in the shape of for example a phone number, an internet address, business card information or other information the user wants transformed. In response to the user input the presentation of the graphical code pattern is modified. After each user input the terminal presents options to save code, continue user input or scan the code, where receive user input can be default. If the terminal can not read the code, the terminal will display this information and request the user to edit the input. Otherwise the code is saved.

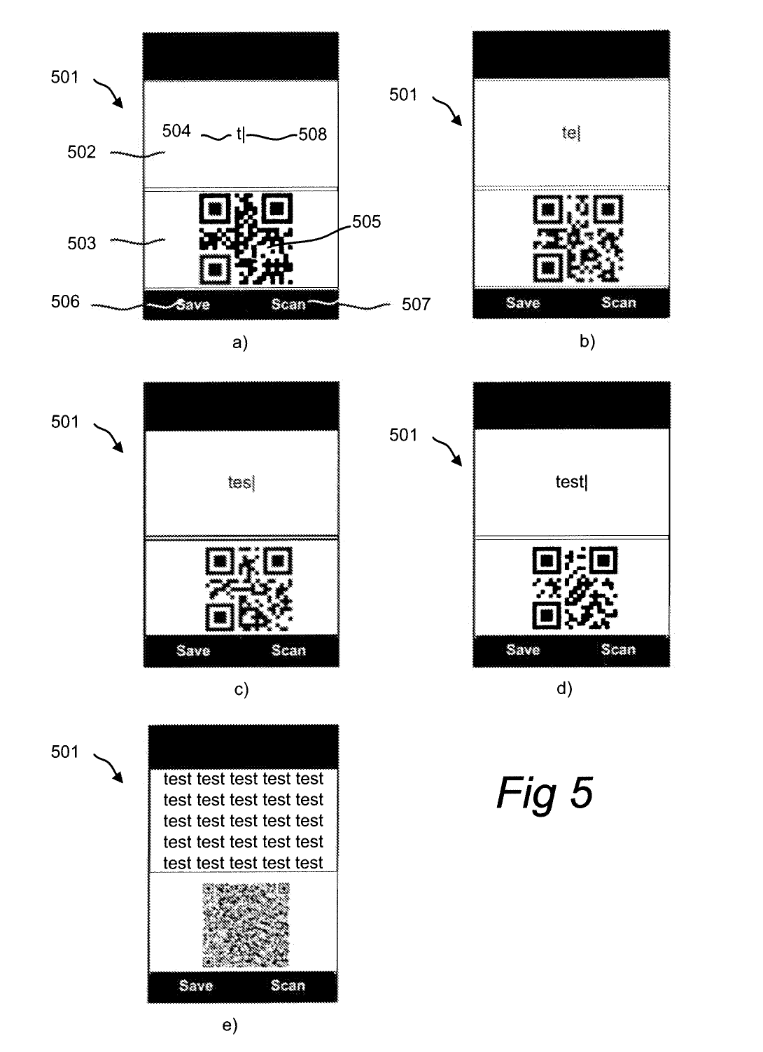

FIG. 5 comprise sections a) to e) which are schematic drawings of an embodiment of how the display can look during input of text. More or less information, soft keys or other features may be available on screen. The sections show a display 501 comprising a first 502 and a second 503 area, in which first area 502 a content 504 to be encoded into a graphical code pattern 505, in this case a 2D matrix code is visible, and in which second part 503 a preview of a graphical code pattern 505 is visible during editing of the content. In this example, the content is a text message, which subsequently may be stored or sent via a messaging service. Further more two soft keys “save” 506 and “scan” 507 and a cursor 508 are shown. The scan function scans the graphical code pattern for readability and could for example contain different settings so it is tested if it is readable under good conditions, i.e. from a piece of paper close by with a good contrast and a camera or scanner specifically adapted to read such graphical code patterns. Or if its readable under not so good conditions, for example if the graphical code pattern is moving, or printed on a t-shirt, or if the scanner is just a regular camera not adapted to read such codes. The numbering applied to section a) also apply to section b-e). As new content 504 is inputted, the graphical code pattern 505 changes and becomes more and more complex as shown in section e). Other ways of displaying the graphical code pattern 505 and the content 504 can be imagined. For example instead of a first and second area visible at the same time, the two area could be placed on each of their tab where the terminal would display either the content or the graphical code pattern. Another option would be to make the two display areas overlap so the graphical code pattern would be displayed in the background of the content.

1. A method for generating a graphical code pattern from a multimedia content, the method comprising:
receiving one or more input and in response editing said multimedia content;
encoding said multimedia content into a graphical code pattern;
displaying the generated graphical code pattern;
characterized by
concurrently with said editing, encoding the multimedia content into said graphical code pattern and displaying the image of said graphical code pattern, such as to provide a preview of said graphical code pattern.

2. A method according to claim 1, wherein said encoding and/or displaying is performed essentially in real time, in instant response with the receipt of an input, such as to continuously provide a current preview of the graphical code pattern.

3. A method according to claim 1, wherein said encoding and/or displaying is performed repeatedly after predetermined time intervals.

4. A method according to claim 1, wherein said encoding and/or displaying is performed repeatedly upon receipt of a predetermined number of input, each representative of an editing action of said multimedia content.

5. A method according to claim 1, wherein said encoding involves encoding to a code pattern comprising QR code, micro QR code, PDF417, DataMatrix, Maxi Code, MiniCode, ezCode, Aztec code, Codablock, ShotCode Vericode, Datastrip Code, CP Code, IIS SuperCode, Dot Code, Bee Tagg code, PaperDisk, mCode, 3-DI Code, Code 1, Snowflake, Optical intelligence 2D, three dimensional code, or any combinations thereof.

6. A terminal adapted for generating a graphical code pattern from a multimedia content comprising a user interface, a processor, a display, and an input acquirer, wherein said input acquirer is adapted to receive an input, said processor is adapted to encode said input into a graphical code pattern, and said display is adapted to display an image of said graphical code pattern,
characterized by
the processor and display being adapted to concurrently with said input acquirer receiving input, encoding and displaying the image of said graphical code pattern, such as to provide a preview of said graphical code pattern.

7. A terminal according to claim 6, wherein said graphical code pattern is QR code, micro QR code, PDF417, DataMatrix, Maxi Code, MiniCode, ezCode, Aztec code, Codablock, ShotCode Vericode, Datastrip Code, CP Code, IIS SuperCode, Dot Code, Bee Tagg code, PaperDisk, mCode, 3-DI Code, Code 1, Snowflake, Optical intelligence 2D, three dimensional code, or any combinations thereof.

8. A terminal according to claim 6, wherein said multimedia content is a text string, an image, a sound clip or any combinations thereof.

9. A terminal according to claim 6, wherein said image preview has an image resolution lower than that of an actual representation of the code.

10. A computer program product embodied in a memory of a device, such as a computer-readable medium, comprising software instructions that, when executed in an electronic apparatus, performs the method according to claim 1.

11. An user interface comprising a display and an input acquirer wherein said input acquirer is arranged to receive user input to be converted into a graphical code pattern and said display is arranged to display said input and said graphical code pattern, characterized by said display is adapted to display an updated image of said graphical code pattern concurrently with said input acquirer receiving input.
